(19) United States
(12) Patent Application Publication
(10) Pub. No.: US 2004/0222098 A1
(43) Pub. Date: Nov. 11, 2004

(54) Method for the manufacture of shaped ceramic bodies

(76) Inventors: Rolf Clasen, Saarbrocken-Dudweller (DE); Jan Tabellion, Riegelsberg (DE); Christian Oetzel, Riegelsberg (DE)

Correspondence Address: KLAUS J. BACH, 4407 TWIN OAKS DRIVE, MURRYSVILLE, PA, 15668, US

(21) Appl. No.: 10/841,601

(22) Filed: May 7, 2004

(30) Foreign Application Priority Data
May 9, 2003 (DE) 103 20 936.0

(51) Int. Cl. H05B 7/00

(52) U.S. Cl. 204/483; 264/430

(57) ABSTRACT

In a method for the manufacture of ceramic sinter bodies including zirconium dioxide for dental applications, wherein the sinter bodies are formed by electrophoretic precipitation of ceramic particles from a suspension including a first electrode onto a porous form which is arranged in the suspension and has the shape of the sinter body to be formed, wherein the porous form is hollow and is filled with an electrically conductive liquid in which a second electrode is disposed and wherein the suspension includes zirconium dioxide and has a pH value of 9.5 to 13 or 2.0 to 5.

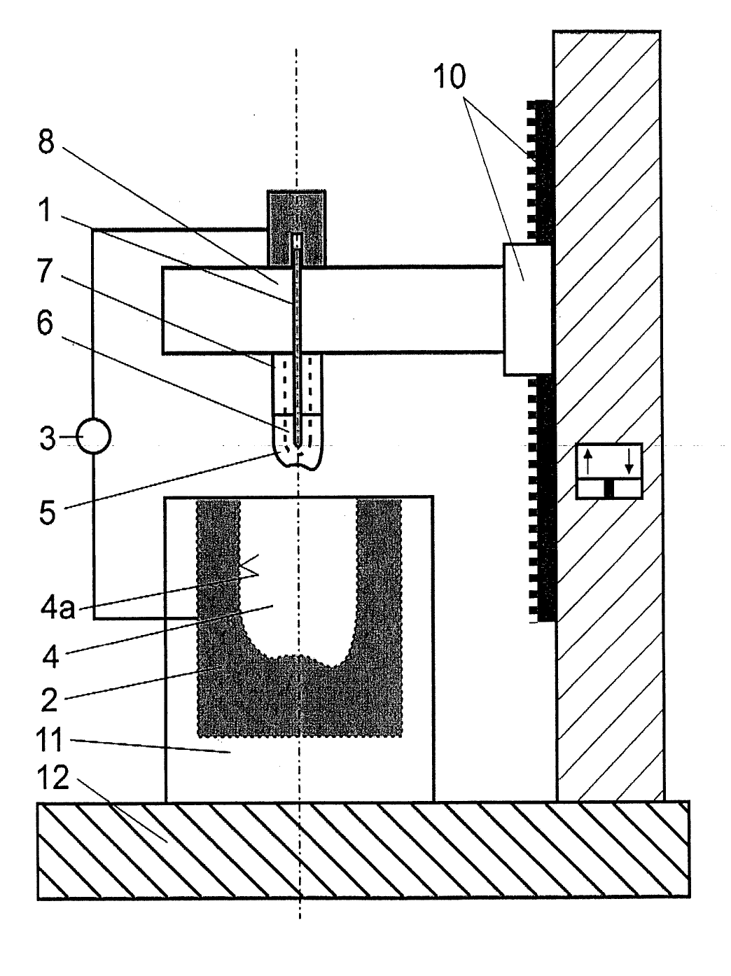

### BACKGROUND OF THE INVENTION

The invention resides in a method for the manufacture of a ceramic sinter body including zirconium dioxide from which, by sintering, shaped bodies can be manufactured for dental applications. The unfinished sinter bodies, that is the bodies to be sintered, are formed by electrophoretic precipitation of ceramic particles from a suspension wherein one of the electrodes is arranged in the suspension for the electrophoretic precipitation.

Non-metallic, that is metal-free, fully ceramic tooth replacement has recently been established as an alternative to fully metallic- and compound restorations for crowns and bridge prostheses. Particularly in the visible denture area, a fully ceramic tooth replacement provides for substantially improved aesthetics which is of substantial advantage when compared with partially or fully metallic dentures. Furthermore, ceramic materials have a high biocompatibility.

For dental applications, zirconium dioxide has been found to be particularly suitable as fully ceramic tooth replacement. Zirconium dioxide has the advantage that it has a high strength and that it counteracts by phase conversion the growth of cracks which may have formed by excessive loads. The only disadvantage of zirconium oxide is that it is difficult to mechanically work or shape parts formed of sintered zirconium oxide. It is therefore desirable to prepare tooth replacement parts which include zirconium dioxide, by means of electrophoretic procedures.

A method of manufacturing any tooth replacement parts, also fully ceramic tooth replacement parts, must fulfill several basic requirements: particularly important is an accurate fit of the prosthesis on the prepared tooth stump. Very close tolerances must be observed. In addition, the equipment needed for the manufacture of the prosthesis should be reasonable and the method should be easy to perform, fast and reasonably inexpensive. In addition, a good reproducibility is important for the method in order to provide for a small failure rate.

WO 99/50480 discloses a method for the manufacture of zirconium dioxide-containing ceramic bodies for dental applications wherein an organic suspension of ceramic particles in a polar organic solvent is used. The suspension is disposed in a container in which two electrodes for the electrophoretic precipitation of the ceramic particles are arranged. A plaster cast of a prepared tooth stump coated with a conductive silver lacquer is immersed into the suspension and forms an electrode. By applying an electric DC voltage of between 50 and 400 Volts to the two electrodes, the ceramic particles are precipitated from the solution so that a sinter body is formed. The sinter body is then dried and subjected to an initial sintering procedure at about 1200° C. Then a glass dross is infiltrated into the sinter body and the filter body is finally sintered at 1100° C.

A disadvantage of this procedure however is the use of organic dispersing compounds which are highly flammable and which are toxic. Furthermore, in the thermal method steps, often toxic crack products of the organic solvents are formed. Accordingly, special protective measures are required. Furthermore, the deposition rate is very low so that high voltages are required or a long deposition time must be accepted.

EP 0 200 242 A2 discloses a method for the manufacture of a glass body wherein from an aqueous suspension with a highly dispersive solid particle content a porous sinter body is formed which is subsequently cleaned and sintered. The sinter body is manufactured by a separation of the phases of the suspension by electrophoresis.

To avoid the formation of large pores in the sinter body caused by bubbles, the electrophoretic precipitation is no longer performed onto an electrode, but onto a porous membrane which is arranged between the two electrodes. The membrane may have the shape of the sinter body to be prepared and has pores which are smaller than the particles being precipitated. Upon application of an electric DC voltage to the two electrodes, the particles are precipitated onto the membrane and the sinter body is formed on the membrane.

From EP 0 200 242 A2, no hints can be derived that with the method described therein, it could also be possible to form ceramic bodies of zirconium dioxide by precipitation.

It is the object of the present invention to provide a method for the manufacture of shaped ceramic bodies of zirconium dioxide for dental applications, which has a high density.

### SUMMARY OF THE INVENTION

In a method for the manufacture of ceramic sinter bodies including zirconium dioxide for dental applications wherein the sinter bodies are formed by electrophoretic precipitation of ceramic particles from a suspension including a first electrode onto a porous form which is arranged in the suspension and has the shape of the sinter body to be formed, the porous form is hollow and is filled with an electrically conductive liquid in which a second electrode is disposed and wherein the suspension includes zirconium dioxide and has a pH value of 9.5 to 13 or 2.0 to 5.

Since the particle are precipitated onto a porous mold, which is disposed in the suspension and which has the form of the desired body, a precipitation body is formed by electrophoretic precipitation in a simple manner which body has a shape which corresponds to the shape of the desired body with only small deviations so that only very little finishing work is needed after the body is formed. This is highly advantageous since as mentioned initially the mechanical finishing of densely sintered zirconium dioxide is very difficult and expensive.

With the arrangement of the other electrode for the electrophoretic precipitation in the body cavity which is filled with an electrically conductive liquid or, respectively, the hollow space filled with an electrically conductive liquid, a very good deposition of zirconium dioxide on the porous body is achieved. Since the body is porous, ions formed during the dissociation of the dispersion medium water as well as all the other free ions present in the system can pass through the body envelope and reach the other electrode. The gas bubbles formed by recombinations develop therefore at the other electrode, not on the body being formed. Therefore an aqueous suspension can be used. The gas bubbles are not enclosed in the body so that no faults occur in the body being sintered. This is particularly advantageous for dental applications. Furthermore, the use of water as a dispersion medium is also very advantageous because, as a result of its high dielectric constant, high deposition rates can be achieved.

With the adjustment of the pH value to about 9.5 to 13, particularly 9.5 to 12.0 and preferably to about 10.0, a precipitation rate suitable for industrial application of the method can be achieved. Although, with a pH value of about 2.0 to 5.0, particularly 2.5 to 4.0, and preferably about 3.5, a precipitation rate suitable for industrial applications can still be obtained the first mentioned setting of the pH value is preferred.

A suspension has been found to be advantageous which, with a pH value of 9.5 to 13.0, has a zeta-potential of minus 30 to minus 70, particularly minus 40 to minus 70, or respectively, with a pH value of 2.0 to 5.0, has a zeta-potential of plus 30 to plus 70, particularly plus 40 to plus 70. In this way, the dispersion has a low viscosity and is easier to process. In addition, the electrophoretic precipitation rate is improved.

It is also advantageous if the electric conductivity of the suspension is between 0.001 and 5 millisiemens per centimeter particularly between 0.001 and 3 millisiemens per centimeter and preferably between 0.001 and 2 millisiemens per centimeter. The viscosity of the solution should be between 1 and 1000 millipascal seconds, particularly between 1 and 500 millipascal seconds.

It has further been found to be advantageous if a strong base such as tetra methyl ammonium hydroxide (TMAH) or sodium hydroxide (NaOH) or respectively, a strong acid such as hydrochloric acid (HCl) is added to the suspension. In this way, the pH value of the suspension can be adjusted in a simple manner.

Furthermore, it has been found to be advantageous if electrosterically acting polyelectrolytes or dispersing agents such as sodium or ammonium salts of long-chain polyacrylic acids (molecule chain length M between 5000 and 100000) in an amount of 0.5 to 3, particularly 0.1 to 1.0 weight % are added to the suspension. In this way, on one hand, the viscosity of the suspension is reduced, whereby the filling degree can be increased. An increased filling degree is again very advantageous for the precipitation rate or, respectively, the density of the body formed. On the other hand, also the isoelectric point of the zirconium dioxide particles is moved to lower pH values. As a result, a higher value zeta potential is obtained already at a pH value of 9.5-11 so that precipitation can take place also there.

With the method according to the invention, a precipitation body for sintering of zirconium oxide can be produced, which has a high density and as a result has a shape which corresponds to the desired shape of the sinter body with only very small deviations. This can be achieved only since, because of the high density of the sinter body, only little shrinking occurs during subsequent sintering, so that mechanical finishing work can be almost completely eliminated.

It has been found to be very advantageous if bi-modal zirconium oxide with particles of a large grain size and particles of small grain size which are distributed in a bi-modal form are used, wherein the average diameter of the particles of large grain size is about 0.3 to 100 micrometers and the average diameter of the particles with the small grain size is about 0.01 to 1 micrometer. In this way, the already high density of the precipitation or sinter body is further increased. It is also very advantageous to use zirconium dioxide with a composition of about 75 to 97 wt %, particularly 90 to 94 wt % and preferably about 92 wt %, large grain particles and about 25 to 3 wt %, particularly 6-10 wt % and preferably 8 wt % small grain particles. Such a composition is not only very advantageous for the density of the precipitation or sinter body but provides also for a very homogeneous body. The precipitation or sinter body obtains in this way, also a high strength so that it is easier to handle.

A further increase of the density and an improved homogeneity of the body can be achieved in that tri-modal zirconium dioxide with particles of larger size, particles of intermediate size and particles of small grain size which are distributed in a tri-modal manner, are used, wherein the average diameter of the particles with the larger grain size is about 0.5 to 100 micrometers, the average diameter of the particles with the intermediate grain size is about 0.1 to 1 micrometer and the average diameter of the particles with the small grain size is about 0.01 to 0.1 micrometer. In this connection, a composition of 70 to 95 wt %, particularly 85 to 92 wt % and preferably 90 wt % of large grain size particles and 3 to 25 wt %, particularly 3 to 8 wt % and preferably 5 wt % of particles of the intermediate grain size and about 1 to 12 wt %, particularly about 2 to 6 wt % particles of the small grain size has been found to be very advantageous.

The particles may be ball-like, cube-like or plate-like. However, a ball-like shape is considered to be advantageous. The particles should have an impurity content of not more than 3 wt %. Furthermore, they should exhibit the least possible interaction with the dispersing liquid. Unstablized particles, partially stabilized or fully stabilized powder particles or combinations thereof may be used. As stabilizing oxide, ceriumoxide (CeCO₂) ytrium oxide (Y₂O₃) may be used.

It is advantageous if the power including the particle is cleaned repeatedly by a non-polar or polar organic or inorganic solvent such as alcohol ether, ester or water especially multiply distilled water before it is dispersed into the suspension.

Particularly advantageous is an embodiment of the invention wherein the fill degree of the suspension is about 50 to 95 wt %, particularly about 75 to 90 wt %. With such a fill degree, a high precipitation rate and a very dense and homogeneous precipitation body is obtained.

It is also very advantageous if the intermediate electric field strength between the electrode disposed in the suspension and the other electrode is about 0.1 to 50 volts per centimeter, particularly 0.5 to 20 volts per centimeter and preferably 1 to 5 volts per centimeter.

In a further embodiment of the invention, pure water such as de-ionized or twice-distilled water is used as the electrically conductive liquid. Preferably, the electrical conductivity of the water should be less than 100 microsiemens per centimeter. For increasing the conductivity, the acids or bases, particularly tetramethylammonium hydroxide may be added. It is very advantageous if sufficient additives are added that the ratio of the conductivity of the electrically conductive liquid to the conductivity of the suspension is about 5 to 50, particularly 10 to 40. However, a conductivity of 100 millisiemens per cm should not be exceeded.

Surprisingly, it has been found that the pores of the porous form do not need to be smaller than the ceramic particles. As materials therefore hardenable porous hydrophilic plastic materials, plasters or porous ceramic structures can be used. Therefore, for the manufacture of the porous form, inexpensive materials can be used which are easy to work.

In another special embodiment of the invention, the electrode disposed in the suspension is so shaped and arranged that it has everywhere the same distance from the surface of the porous form. In this way, a precipitation body is formed which has only very slight deviations in wall thickness and is highly homogeneous. This property can be still further improved when the other electrode disposed in the cavity of the form has all over the same distance from the surface of the porous form.

It is particularly advantageous if the precipitation body or sinter body is subjected to a final electrophoretic densification in an aqueous suspension which includes a ceramic powder whose particles are smaller than the average pore diameter of the body deposited on the form. This results in an increase of the density of the sinter body. The final densification may occur immediately following the electrophoretic precipitation. However, it has been found to be particularly advantageous if the precipitation body is first dried and the sinter body obtained thereby is electrophoretically finally densified after the drying.

As base powder for the suspension of the electrophoretic final densification of the precipitated body or sinter body, nanoscale ceramic powders with a D50 value of between 1 and 100 nanometer, preferably between 1 and 50 nanometer may be used if the pores of the precipitated body or sinter body have an average diameter of about 100 nanometer. As start out material, preferably zirconium dioxide powder is used. The powder distribution should have an impurity content of not more than 3 wt %. Also, preferably, they should have as little interaction with the dispersion medium as possible. The powders may be—depending on the start-out material—differently doped. For example, with the use of zirconium dioxide powders, partially as well as fully stabilized powders may be used. As stabilized oxide preferably ceriumoxide (CeO₂) and yttrium oxide (Y₂O₃) are used.

Further details, features and advantages of the invention will become more readily apparent from the following description of a particular embodiment thereof described below with reference to the accompanying drawings.

### BRIEF DESCRIPTION OF THE DRAWING

The sole FIGURE shows an arrangement for performing the method according to the invention.

### DESCRIPTION OF A PREFERRED EMBODIMENT

As shown in the FIGURE, the arrangement comprises a dome-shaped electrode 1 which is arranged in a recess 6 which may be called a compensation chamber of a porous material form 5. The porous form 5 has the shape of a sinter body to be produced by the arrangement. It is formed as a negative form by methods common in dental techniques from a tooth stump. As material, a castable, hardenable porous copying material such as plastic or plaster, particularly expanding dental plaster may be used.

The porous form 5 is mounted to a support structure 7 through which the dome-shaped electrode 1 extends. The support structure 7 consists of a non-porous material, preferably of a dielectric material and particularly of a hydrophobic polymer at the surface of which no electrophoretic precipitation can occur.

The support structure 7 is mounted on a support arm 8, which is supported on an electrically controllable linear operating device 10. The support arm 8 includes an opening through which the domed rod-like electrode 1 extends. The electrode 1 is so mounted that it can extend into the recess 6 to different depths. At the side remote from the support structure 7, the rod-like electrode 1 may consist of an electrically conductive material such as a metal, graphite, or a conductive plastic material. Preferably, the rod-like electrode 1 consists of stainless steel or of a noble metal.

Below the porous form 5, a counter electrode 2 is arranged which includes a recess 4 forming a suspension chamber whose wall corresponds to the shape of the porous form 5. The counter electrode 2 is arranged in an electrically nonconductive element 11, which is supported on a base plate 12. In this way, it is prevented that the electric field present between the dome-shaped electrode 1 and the counter electrode 2 during the electrophoretic precipitation is affected. The counter electrode 2 is also connected to the DC voltage source 3.

The counter electrode 2 consists of a metallic material such as a stainless steel or noble metal. Alternatively, it may consist of a nonmetallic material, preferably plaster or a polymer material which is coated by an electrically conductive lacquer.

Before the application of an electric voltage to the two electrodes 1, 2 the porous form 5 is preferably soaked with the dispersion liquid used for the suspension and is mounted on the support structure 7. Then the recess 4 of the counter electrode 2 is filled with the suspension. In addition, the compensation chamber 6 is filled with the suspension. The level of both liquid bodies should be above the upper edge of the porous form 5. In this way, a change of the wall thickness in the edge area of the precipitated sinter body is avoided.

Subsequently, the dome-like electrode 1 is inserted into the liquid such that it is disposed centrally within the compensation chamber 6. Then the support arm 8 is moved downwardly, vertically by the electrically controlled linear operating device 10 such that the porous form 5 is immersed with its underside centrally into the suspension in the recess 4 of the counter electrode 2. Now the DC voltage is applied to the two electrodes 1, 2.

When the electrical DC field is established by the DC voltage source 3, a sinter body is precipitated onto the outside of the form 5. The electrical DC field is then discontinued and, with the electrically controlled linear operating device 10, the support arm 8 is moved vertically upwardly and the filter body is removed thereby from the suspension.

The precipitated body is then dried on the porous form 5 for 10 to 60 minutes. This can be done in air or under a controlled atmosphere. Subsequently, the sinter body is removed from the form and further dried in air or under a controlled atmosphere. When the sinter body is completely dry, it is sintered.

For the electrophoretic precipitation, an electrical DC voltage of 2-200 V is applied between the electrodes 1, 2, whereby an average electrical field strength of 1 to 5 V/cm is generated. Since the suspension chamber 4 is adapted in its shape to the form 5 about the same electrical field strength is effective anywhere on the surface of the sinter body being deposited so that the precipitated sinter body has a homogeneous wall thickness.

By the electrophoretic force which is effective in the direction toward the electrode 1, the ceramic surface-charged particles in the suspension are moved toward the membrane-like form 5 and are deposited on the form 5. The sinter body is formed when the attraction forces effective on the particles, that is mainly the electrophoretic forces, exceed the repulsion forces. The electrophoretic force depends mainly on the electric field, the dielectricity number, the dispersion medium and the zeta potential of the dispersed ceramic particles.

The properties of the resulting sinter body such as density and wall thickness depend, in addition to the mentioned process parameters, on the fill degree of the suspension, the average particle diameter and similar. In the electrophoretic precipitation furthermore osmotic and electro-osmotic effects come into play. Therefore the conductivity of the suspension liquid represents another parameter. In addition, the properties of the material of the membrane form 5 such as pore radii distribution and body density affect the electrophoretic precipitation of the particles.

The process is characterized in that the precipitation rates are between 0.1 and 10.0 g/min-cm² and, preferably between 0.2 and 1.0 g/min-cm².

With the parameters of the electrophoretic precipitation described, the properties of the parameters or particles used and the suspensions formed therefrom, sinter bodies with very good microstructural homogeneity and sufficient body strength can be made. The maximum wall thickness deviation is between 2 and 10%. Sinter bodies with densities of 50 to over 75% of the theoretical density can be produced.

The sinter bodies obtained in this way are finally sintered in conventional sinter ovens or, respectively, by laser or microwave heating. The temperatures needed for the sintering procedure are, dependent on the base material ZrO₂, between 1300° C. and 1700° C. The sintering behavior depends on the density of the sinter body, the content of nano-scale particles in the sinter body and on possible sinter additives. In this way, fully ceramic tooth replacement parts with a relative density of over 98% of the theoretical density can be manufactured.

Optionally, the dried and possibly presintered sinter body may be electrophoretically further densified for increasing the density of the sinter body. The further densification is achieved with the same setup by the electrophoretic impregnation of the open-pore sinter body with nanoscale suspension of a low filling degree.

### EXAMPLE 1

50 g bi-distilled water was filled into 300 ml plastic cup, and 0.015 wt % tetramethyl ammonium hydroxide (TMAH) was added. By means of commercially available dissolvers, 307.2 g cerium-doped zirconium oxide powder (15.5 wt % doped ceriumoxide, average particle size 3 μm was stirred in. The suspension prepared in this way accordingly had a solid material content of 80.0 wt %, at a stirring speed of 24 rpm, the viscosity was 129 Pas, the specific electric conductivity was 8.4 mS/cm and the pH value was 13.

The suspension prepared in this way was filled into the precipitation chamber 4. The compensation chamber 6 was filled with bi-distilled water to which 0.018 wt % TMAH was added. As material for the porous form 5, an expanded plaster was used. The porous form was soaked before the precipitation for 5 min with bi-distilled water in order to avoid capillary effects. The precipitation was performed in this example anodically. The distance between the anode and the cathode was 14 mm. A DC voltage of 15 V was applied to the electrodes for 3 min.

After the electrophoretic precipitation, the sinter body formed on the plaster form was dried for about 30 minutes and the plaster form was then removed. It was found difficult to remove the tooth cap from the plaster stump without cracking since the strength of the sinter body formed from a suspension with purely microcrystalline powder is small. With REM pictures, the bubble deposition of the tooth cap could be shown. In addition, a maximum wall thickness deviation of about 5% was obtained. The relative sinter body density as determined by volume displacement (principle of Archimedes) was 58.9%. The sinter body prepared in this way, after drying, was sintered in a conventional sinter oven at 1750° C. for 3 hours with a heat-up rate of 6° C./min. The tooth cap prepared in this way had a relative density of 90%. The linear shrinkage was 10%.

### EXAMPLE 2

50 g bi-distilled water was filled into a 300 ml plastic cup. For the adjustment of the pH value to 11, 0.015 wt % tetramethyl ammonium hydroxide (TMAH) was added. As dispersion aid 0.4 g sodium salt of a polyacrylic acid was added which corresponds to a content of 1.5 wt % dwb. Using commercially available solvents, 26.92 g yttrium-doped nano-scale zirconium oxide powder (5 wt % doped yttrium oxide, average particle size 12 nm) were stirred in. The suspension prepared in this way had a solid material content of 35 wt %, the specific electric conductivity was 2.0 mS/cm and the pH value was 9.6. The suspension prepared in this way was filled into the precipitation chamber 4. The compensation chamber 6 was filled with bi-distilled water to which 0.018 wt % TMAH was added. As material for the porous form 5, an expanded plaster was used. The porous form 5 was soaked in distilled water for about 5 min. before the precipitation in order to avoid capillary effects. The precipitation was performed in this example anodically. The distance between the anode and the cathode was 14 mm. To the electrodes, an electric DC voltage of 15 V was applied for 3 min.

After the electrophoretic precipitation, the sinter body formed on the plaster form was dried for about 20 min and then removed from the form. With REM pictures, a bubble-free formation of the tooth cap could be shown. Furthermore a maximum wall thickness deviation of about 5% was obtained. The relative sinter body density as determined by the principle of Archimedes was 33.5%.

The sinter body prepared in this way was sintered at 1400° C. in an oxidizing atmosphere for three hours with a heat-up rate of 6° C./min. The tooth cap made in this way had a relative density of 95%. The linear shrinkage was 27%. The high drying and sintering shrinkage obtained by the use of pure nano-powder can not fully be compensated for by the use of expanding plaster.

### EXAMPLE 3

50 g bi-distilled water was filled into a 300 ml plastic cup. For the adjustment of the pH value to 11, 0.015 wt % TMAH was added. As dispersion aid, 0.51 g ammonium salt of a polyacrylic acid was added which corresponds to a content of 0.18 wt % dwb. With the aid of a commercially available solvent, first 224.7 g undoped zirconium oxide powder (5 wt % doped yttrium oxide, average particle size 12 nm) were stirred in. Subsequently, 260.7 g cerium-doped zirconium oxide (15.5 wt % doped ceriumoxide, average particle size 3 μm) were stirred into the suspension. The suspension prepared in this way had accordingly a solid material content of 85 wt % with a nano-powder content of 8 wt % dwb. The viscosity was at a stirring speed of 64 rpm 600 mPas, the specific electric conductivity was 0.88 mS/cm and the pH value was 8.2.

The suspension prepared in this way was filled into the precipitation chamber 4. The compensation chamber 6 was filled with bi-distilled water to which 0.2 wt % TMAH was added. As material for the porous form 5, an expansion plaster of the company Giulini was used. Before the precipitation, the form was soaked for 5 min. with bi-distilled water in order to avoid capillary effects. The precipitation in this case occurred anodically. The distance between the anode and the cathode was 14 mm. An electrical DC voltage of 15 V was applied to the electrodes for 3 min.

After the electrophoretic precipitation, the sinter body formed on the plaster form was dried for about 30 min and then removed from the form. The tooth cap sinter body strength was noticeably higher than that of the sinter body obtained in example 1 from a suspension with a cerium-doped zirconium powder (average particle size 3 μm). With REM pictures, a bubble-free deposition of the tooth cap could be shown. A maximum wall thickness deviation of about 5% was obtained. The relative sinter body density as determined by the principle of Archimedes was 73.3%.

The sinter body so prepared and dried was sintered at 1750° C. in an oxidizing atmosphere for 3 hrs with a heat-up rate of 6° C./min. The tooth cap manufactured in this way had a relative density of 98%. The linear shrinkage was 10%.

### EXAMPLE 4

50 g bi-distilled water was filled into a 300 ml plastic cup. For the adjustment of the pH value to 11, 0.015 wt % tetramethyl ammonium hydroxide (TMAH) was added. As dispersion aid, 0.51 μg ammonium salt of a polyacrylic acid was added which corresponds to a content of 0.18 wt % dwb. With a commercially available solvent, first 5.7 g yttrium-doped nano-scale zirconium oxide powder (5 wt % doped yttrium-oxide, average particle size 0.5 μm) was stirred into the suspension. Subsequently, under the same conditions, 260.7 cerium-doped zirconium oxide powder (average particle size 3 μm) were stirred in and dispersed.

The suspension prepared in this way had accordingly a solid material content of 86.0 wt % with a nanopowder content of 2 wt % and a submicrometer powder content of 6 wt % dwb. The viscosity was 420 in Pas, the specific electric conductivity was 0.85 μs/cm and the pH value was 9.3.

The suspension so prepared was filled into the precipitation chamber 4. The compensation chamber 6 was filled with bi-distilled water to which 0.018 wt % TMAH was added. As material for the porous form 5, an expanding plaster was used. The form 5 was soaked before the precipitation for about 5 min. in bi-distilled water in order to avoid capillary effects. The precipitation was performed anodically in this example. The distance between the anode and the cathode was 14 mm. A DC voltage of 15 V was applied to the electrodes for 3 min. After the electrophoretic precipitation, the sinter body formed on the plaster form was dried for about 30 min and then removed form the form. The strength of the sinter body was in comparison with the cap described with respect to example 1 from a suspension with a pure cerium-doped zirconium dioxide powder (average particle size 3 μm) substantially higher. The removal of the cap from the form occurred therefore without any problems. With REM-pictures, the bubble-free deposition of the tooth cap could be shown. The maximum wall thickness deviation was about 5%. The relative density of the sinter body as determined by the Archimedes principle was 75%.

The sinter body so prepared and dried was sintered in an oxidizing atmosphere at 1750° C. for 3 hours at a heat-up rate of 6° C./min. The finished tooth cap made in this way had a relative density of 98%. The linear shrinkage was 9%.

What is claimed is:

1. A method for the manufacture of ceramic sinter bodies including zirconium dioxide, for dental applications, said method comprising the steps of: providing a hollow porous form of the shape of the desired sinter body, filling the hollow porous form with an electrically conductive liquid, providing a suspension of ceramic particles including zirconium dioxide and filling said suspension into a cavity, arranging said porous form in said cavity filled with said suspension of ceramic particles and adjusting the suspension to a pH value of one of 9.5 to 13.0 and 2.5 to 4.5, said cavity being formed by a structure forming a first electrode and said porous form having a second electrode disposed therein, and applying a DC voltage between said first and second electrodes for the electrophoretic precipitation of said ceramic particles out of said suspension onto said porous form.

2. A method according to claim 1, wherein bi-modal zirconium dioxide with particles of relatively large size and particles of relatively small size are used wherein the average diameter of said large size particles is about 0.3 to 100 micrometer and the average size of the small size particles is 0.01 to 1 micrometer.

3. A method according to claim 2, wherein said bi-modal zirconium dioxide comprises 75-97 wt % large size particles and 25-3 wt % small size particles.

4. A method according to claim 3, wherein the large size particles are present in an amount of about 92 wt % and the small-size particles are present in an amount of about 8 wt %.

5. A method according to claim 1, wherein tri-modal zirconium dioxide including particles of large grain size, intermediate grain size and small grain size are used with the average diameter of the large grain size particles being 0.5 to 100 micrometer, that of intermediate grain size being 0.1 to 1 micrometer and that of small grain size being 0.01 to 0.1 micrometer.

6. A method according to claim 4, wherein said tri-modal zirconium dioxide comprises large grain size particles in an amount of 70 to 95 wt %, intermediate grain size particles in an amount of 3 to 25 wt % and small grain size particles in an amount of 1 to 12 wt %.

7. A method according to claim 6, wherein said large grain size particles are present in an amount of about 90 wt %, said intermediate size particles are present in an amount of about 5 wt % and said small grain size particles are present in an amount of 2-6 wt %.

8. A method according to claim 2, wherein the particle fill degree of said suspension is 50 to 95 wt %.

9. A method according to claim 8, wherein the particle fill degree of said suspension is 75 to 90 wt %.

10. A method according to claim 1, wherein the average electric field strength between the first electrode arranged in said suspension and said second electrode disposed in said porous form is 0.1 to 50 V per centimeter.

11. A method according to claim 10, wherein the electric field strength between said first and second electrodes is 1.0 to 5.0 V per cm.

12. A method according to claim 1, wherein said electrically conductive liquid in said porous form is pure water including de-ionized and twice distilled water.

13. A method according to claim 1, wherein the ratio of the conductivity of the electrically conductive liquid and the conductivity of the suspension is 5 to 50.

14. A method according to claim 1, wherein the ratio of the conductivity of the electrically conductive liquid and the conductivity of the suspension is 0.1 to 0.3.

15. A method according to claim 1, wherein said suspension is one of a strong base and a strong acid.

16. A method according to claim 15, wherein said suspension is one of tetramethylammonium hydroxide (TMAH) and hydrochloric acid (HCl).

17. A method according to claim 1, wherein said form consists of a moldable, hardening and porous material.

18. A method according to claim 1, wherein said first electrode in said suspension is shaped such that it is uniformly spaced from the surface of said form onto which said particles are precipitated from said suspension.

19. A method according to claim 1, wherein said sinter body is electrophoretically finally densified in an aqueous suspension which includes ceramic particles of a diameter smaller than the average pore diameter of the sinter body precipitated onto said form.
